(19) United States
(12) Patent Application Publication
(10) Pub. No.: US 2022/0019217 A1
(43) Pub. Date: Jan. 20, 2022

(54) TRAVEL CONTROL APPARATUS, TRAVEL CONTROL METHOD, AND COMPUTER PROGRAM

(71) Applicant: KABUSHIKI KAISHA TOSHIBA, Tokyo (JP)

(72) Inventors: Yoshikazu YAMANE, Tokyo (JP); Michio YAMASHITA, Tokyo (JP); Noriyuki HIRAYAMA, Tokyo (JP); Hideyuki AISU, Kawasaki (JP); Shizu SAKAKIBARA, Kawasaki (JP)

(73) Assignee: KABUSHIKI KAISHA TOSHIBA, Tokyo (JP)

(21) Appl. No.: 17/196,576

(22) Filed: Mar. 9, 2021

(30) Foreign Application Priority Data
Jul. 16, 2020 (JP) 2020-122256

(51) Int. Cl. G05D 1/00; G05D 1/02

(52) U.S. Cl. CPC G05D 1/0027; G05D 1/0214; G05D 1/0287

(57) ABSTRACT

According to one embodiment, a travel control apparatus includes a first transmitter configured to transmit first move command data for instructing a first mobile object to travel on a first route; an operation planner configured to generate a second route for a second mobile object, according to an execution situation of the first move command data by the first mobile object; and a second transmitter configured to transmit second move command data for instructing the second mobile object to travel on the second route.

### CROSS REFERENCE TO RELATED APPLICATIONS

This application is based upon and claims the benefit of priority from the prior Japanese Patent Application No. 2020-122256, filed on Jul. 16, 2020, the entire contents of which are incorporated herein by reference.

### FIELD

Embodiments described herein relate to a travel control apparatus, a travel control method, and a computer program.

### BACKGROUND

An operation control system has been known that receives conveyance requests from the outside, and plans routes for and issues instructions of travel on the routes to a plurality of mobile objects. In this system, every time each mobile object passes through an interference point, the mobile object refers to a management table that stores exit times and the like, and predicts presence or absence of an interference with another mobile object. In case an interference is predicted, the mobile object is caused to replan another route.

According to this technique, upon occurrence of a new conveyance request, in order to avoid a collision between a mobile object that executes a new conveyance request and a mobile object that is executing another conveyance request before the occurrence of the new conveyance request, a deadlock or the like, all the motions of mobile objects that are executing other conveyance requests are sometimes stopped. Accordingly, there is a problem of reducing the efficiency of the entire system.

### BRIEF DESCRIPTION OF THE DRAWINGS

FIG. 1 is a block diagram of an operation management apparatus as a travel control apparatus according to the present embodiment;

FIG. 2 is a top view schematically showing how operation of a plurality of mobile objects are controlled;

FIGS. 3A and 3B are diagrams showing examples of a collision and a deadlock;

FIG. 4 is a diagram showing a simple example of a travel path network;

FIG. 5 is a diagram showing an example of structure information about the travel path network;

FIGS. 6A and 6B are diagrams showing an example of information about each arc (virtual travel path) and reference node;

FIG. 7 is a diagram showing an example of virtual areas set on respective travel paths coupled to a reference area;

FIG. 8 is a diagram showing an example of a virtual area DB;

FIG. 9 is a diagram showing an example in which virtual nodes are added to structure information about a travel path network;

FIG. 10 is a diagram showing an example of operation information;

FIG. 11 is a diagram showing an example of an operation plan;

FIG. 12 is a diagram showing a state where AGV0 is located at a departure point indicated by the operation plan;

FIGS. 13A and 13B are diagrams showing examples of move command data generated for AGV0 and AGV1;

FIG. 14 is a diagram showing a state where AGV1 is located at a departure point indicated by the operation plan;

FIG. 15 is a diagram showing an example of a pending task DB;

FIG. 16 is a diagram showing an example where the state of operation information about AGV1 is updated to “PENDING”;

FIG. 17 is a diagram showing an example where the state of operation information about AGV1 is updated to “UNEXECUTED”;

FIG. 18 is a diagram showing a state after a notice that AGV0 has passed through an area Na;

FIG. 19 is a diagram showing an example where the state of operation information about “AGV1” is updated from “UNEXECUTED” to “IN EXECUTION”;

FIG. 20 is a flowchart of an operation example of the operation management apparatus according to the present embodiment; and

FIG. 21 is a diagram showing a hardware configuration of the operation management apparatus of FIG. 1.

### DETAILED DESCRIPTION

According to one embodiment, a travel control apparatus includes a first transmitter configured to transmit first move command data for instructing a first mobile object to travel on a first route; an operation planner configured to generate a second route for a second mobile object, according to an execution situation of the first move command data by the first mobile object; and a second transmitter configured to transmit second move command data for instructing the second mobile object to travel on the second route.

The embodiments of the present invention will be described below with reference to the accompanying drawings.

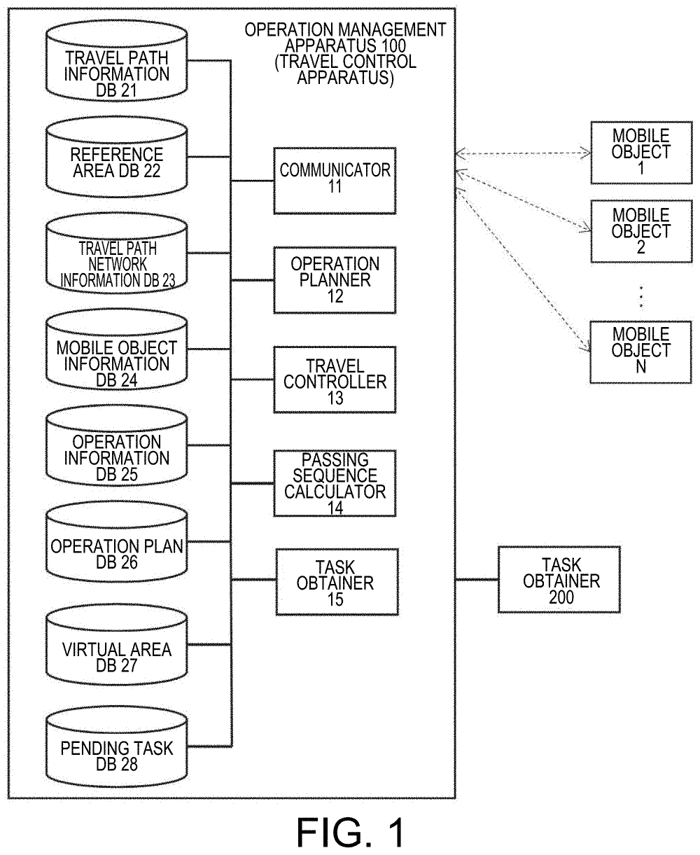

FIG. 1 shows a block diagram of an operation management apparatus as a travel control apparatus according to the present embodiment. The operation management apparatus 100 includes a communicator 11 (a first transmitter and a second transmitter), an operation planner 12, a travel controller 13, a passing sequence calculator 14, a task obtainer 15, a travel path information database (DB) 21, a reference area DB 22, a travel path network information DB 23, a mobile object information DB 24, an operation information DB 25 (operation information storage), an operation plan DB 26, a virtual area DB 27, and a pending task DB 28. The operation management apparatus 100 is connected to a task generation apparatus 200 (operation information generation apparatus) in a wired or wireless manner.

The operation management apparatus 100 creates, for example, an operation plan for efficiently controlling operations of a plurality of mobile objects 1 to N (travel, and work, such as loading and unloading loads) when these mobile objects autonomously travel in a travel path network that includes a travel area, which is a free plane. During creation of the operation plan, a collision or a deadlock is prevented from occurring among the mobile objects. The plurality of mobile objects 1 to N are autonomously movable mobile objects that are autonomously movable mobile objects, such as AGVs, autonomous mobile robots, and autonomous vehicles (e.g., self-driving cars).

The plurality of mobile objects 1 to N travel, for example, in the travel path network, such as a factory, a storehouse, or facility premises. The plurality of mobile objects 1 to N, for example, carry rechargeable batteries, and carry out motions, such as travel or loading and unloading of loads using power accumulated in batteries.

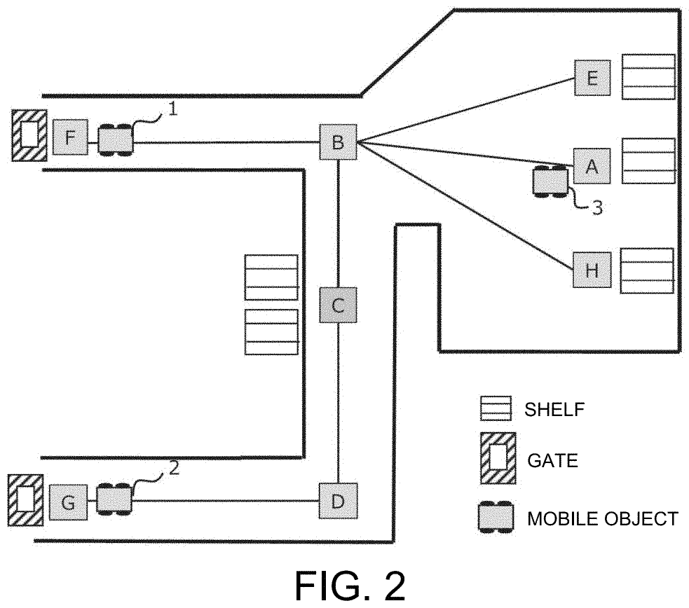

FIG. 2 is a top view schematically showing how operation of a plurality of mobile objects are controlled in a travel path network. A plurality of areas (reference areas) A, B, C, D, E, F, G, and H serving as references are set in the travel path network. Between each pair of reference areas, there is a passage (travel path) along which a mobile object can move. In this way, the travel path network includes a plurality of reference areas as well as a plurality of travel paths among the plurality of reference areas. The reference areas are set corresponding to any locations such as an intersection of travel paths or ends of travel paths. Gates are provided in the reference areas F and G and shelfs are provided in the reference areas A, E, and H. The reference area B corresponds to an intersection of a plurality of travel paths.

Here, each reference area may be located in a specific position or may be an area having a specific range. For example, if the travel path network is represented by an X-Y plane, reference areas are identified by X-Y coordinates. When height is taken into consideration, reference areas are identified by X-Y-Z coordinates. Alternatively, each reference area may be identified by a group of a plurality of X-Y coordinates. For example, when the reference area is rectangular, the reference area may be identified by a group of X-Y coordinates of each vertex. It is assumed below that the reference areas are identified by X-Y coordinates.

A plurality of reference areas are managed as reference nodes by being associated with coordinates on map data of the travel path network. Reference nodes and corresponding reference areas are denoted by the same reference signs for convenience of explanation. A line (arc) linking each pair of reference areas is managed as a virtual travel path along which a mobile object travels. Reference nodes and virtual travel paths are stored in advance in the form of data. Solid lines in FIG. 2 are lines (which correspond to virtual travel paths) linking reference nodes. If two or more mobile objects can run in parallel between reference nodes, the reference nodes may be linked by two or more lines. Data on reference nodes and virtual travel paths are defined on map data. The map data may be defined in advance in the form of CAD (Computer-Aided Design) drawings or other drawings. Alternatively, if the mobile objects have a function to create environmental maps using a self-position detection function, an environmental map may be created using this function. Note that the virtual travel paths have the shape of a straight line, a curved line, or a combination thereof.

The mobile objects 1 to 3 have an autonomous travel function. More specifically, the mobile objects 1 to 3 have a function to generate lines of flow along travel paths among reference areas by themselves and autonomously travel along the formed lines of flow. As an example, when moving from a reference area B to a reference area C, if there is no obstacle between the reference area B and reference area C, a given one of the mobile objects generates a line segment linking the position of the reference area B and position of the reference area C as a line of flow and autonomously travels along the line of flow. The line of flow generated by the mobile object may or may not coincide with a virtual travel path between the reference node B and reference node C. In moving between the two reference nodes, the mobile object may have a function to travel along a virtual travel path as a recommended travel path and avoid any temporary obstacle found on the virtual travel path.

Note that a travel path that provides leeway for mobile objects to travel by avoiding a deadlock or the like may be treated as a travel path on which no contention occurs between the mobile objects. For example, because a travel path BE (travel path between reference area B and reference area E; the same applied hereinafter), travel path BA, travel path BH, and other travel paths in FIG. 2 have enough leeway to allow mobile objects to go past each other, no deadlock or the like will occur even if two mobile objects travel in a head-on direction. For example, one of the mobile objects waits on the side of the travel path while the other mobile object moves along the line of flow on the travel path. When the second mobile object has passed through the travel path, the first mobile object resumes moving. On the other hand, because the travel path BC does not have enough leeway to allow mobile objects to go past each other, if two mobile objects travel in a head-on direction on the travel path, a deadlock or the like may occur.

Note that the mobile objects can move forward, backward, or both forward and backward. The mobile objects may be rotatable and thus capable of making forward/backward direction changes. Also, the mobile objects may be capable of moving in directions such as oblique directions other than forward/backward directions.

Sensors configured to detect states of mobile objects, communication devices configured to communicate with the mobile objects or both of them may be placed in reference areas, travel paths, shelves, gates, or any other locations. In that case, the sensors are connected to at least either of the operation management apparatus 100 and communication devices by wire or radio.

Under the control of the operation management apparatus 100 in FIG. 1, each mobile object is caused to travel in the travel path network according to assigned operation information. For example, the mobile object carries a load received from a gate to another gate. There are cases in which the work of unloading or loading loads from/onto a shelf is carried out in the process of movement. Specifically, each mobile object carries out such work by receiving move command data generated by the operation management apparatus 100 based on operation information, and executing instructions contained in the move command data. Note that there can be cases in which the mobile object only moves without conveying loads.

Now, collisions and deadlocks will be described.

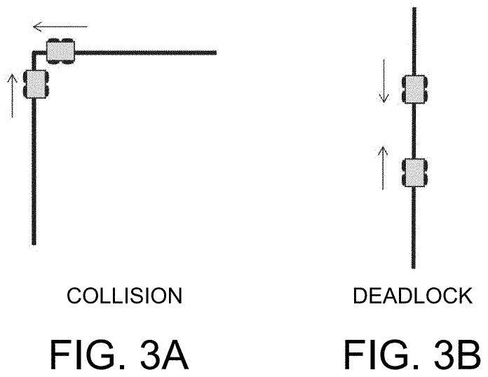

FIG. 3A shows an example of a collision. FIG. 3B shows an example of a deadlock. In FIGS. 3A and 3B, travel paths are represented by straight lines for convenience. In FIG. 3A, two mobile objects travel toward an intersection along two travel paths leading to the intersection, and arrive at the intersection at the same time, resulting in a collision. In FIG. 3B, two mobile objects travel in opposite directions along the same travel path. If the two mobile objects can only move forward, the two mobile objects cannot go backward and thus cannot move to a desired area (intersection, end, or the like), which results in a deadlock.

The travel path network information DB 23 stores structure information about the travel path network therein. The structure information about the travel path network includes reference nodes and virtual travel paths (arcs). The reference nodes and the virtual travel paths (arcs) are associated with map data on travel areas. The reference nodes correspond to reference areas. The reference areas are set at an intersection of a plurality of travel paths or ends of travel paths as an example. However, the reference areas may be set in any locations on travel paths. Examples of such locations include loading/unloading sites and waiting sites.

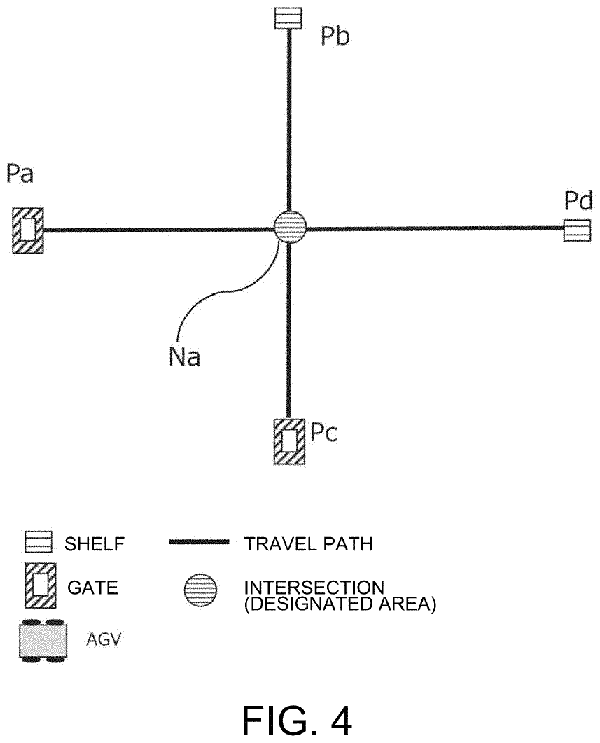

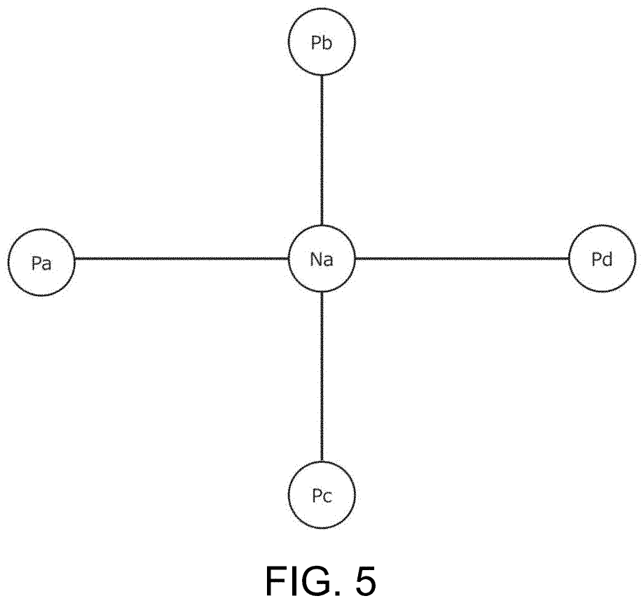

FIG. 4 is a diagram showing a simple example of a travel path network. FIG. 5 shows an example of structure information about the travel path network of FIG. 4, the information being stored in the travel path network information DB 23. The travel path network of FIG. 4 includes five reference areas and four travel paths. Here, the travel paths are represented by straight lines for convenience. A reference area Na is an intersection at which the four travel paths intersect and reference areas Pa, Pb, Pc, and Pd are ends of the four travel paths. Shelves are placed in the reference areas Pb and Pd and gates are provided in the reference areas Pa and Pc. The reference areas Pa, Pb, Pc, and Pd can also serve as departure points or arrival points of mobile objects as an example.

In the structure information on the travel path network of FIG. 5, virtual travel paths are represented by straight lines coupling (or connecting) reference nodes. Each circle represents a reference node (reference area), and straight lines tying the circles represent arcs (virtual travel paths). The reference nodes are denoted by the same reference signs as the corresponding reference areas.

The travel path information DB 21 stores information about the arcs (virtual travel paths) and information about the reference nodes in the structure information on the travel path network as travel path information. The travel path information includes arc IDs (travel path IDs) and IDs of the nodes on opposite ends of each arc (i.e., IDs of the areas on opposite ends of each travel path).

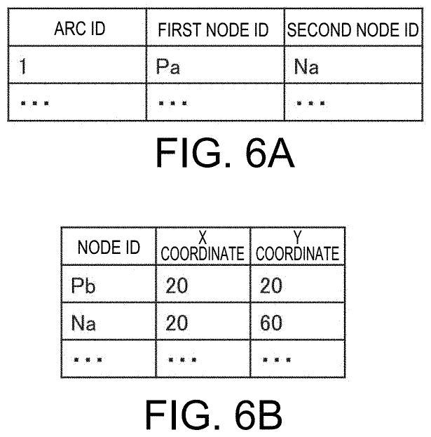

FIG. 6A shows an example of information about each arc (virtual travel path) stored in the travel path information DB 21. In FIG. 6A, for example, the ID of the arc between the reference nodes Pa and Na is 1 and the reference nodes on opposite ends of the arc is Pa and Na. Distances between reference nodes (distances of travel paths) may be stored by being associated with the arc IDs. Alternatively, the distance of the travel path may be calculated based on the positions of the reference nodes on opposite sides of each arc. Also, information about structure and arrangement of each travel path including the width, height, material, coefficient of friction, and slope of the travel path may be stored.

The information about the reference nodes in the structure information on the travel path network is stored in the reference area DB 22. For example, reference node IDs, X coordinates, and Y coordinates are stored as the information about the reference nodes. The positions of the reference nodes correspond, for example, to positions (coordinates) of the reference areas corresponding to the reference nodes.

FIG. 6B shows an example of information about reference nodes stored in the travel path information DB 21. For example, the coordinates of the reference node Pb are (X, Y)=(20, 20). That is, the position of the reference area corresponding to the reference node Pb is (X, Y)=(20, 20). Also, the position of the reference node Na is (X, Y)=(20, 60). That is, the position of the reference area Na corresponding to the reference node Na is (X, Y)=(20, 60).

The virtual area DB 27 stores information about virtual areas set to the travel path network. The virtual area is set for at least one reference area, in a plurality of travel paths coupled to the reference area. Specifically, the virtual area DB 27 stores virtual nodes that represent the virtual areas, by associating the virtual nodes with reference nodes and virtual travel paths (arcs).

The virtual area is used to manage a passing sequence of mobile objects. Here, the virtual area is set on each travel path coupled (or connected) to reference areas, at a position away from the reference areas. That is, in the structure information on the travel path network, a virtual node is set on each arc coupled to reference nodes, at a position away from the reference nodes. Virtual areas may be set for all the reference areas on the travel path network or specific reference areas such as the reference area corresponding to the intersection, reference areas corresponding to the ends of travel paths, or both reference area corresponding to the intersection and reference areas corresponding to the ends of travel paths. Setting of virtual areas may be specified by a user, who is an operator of the operation management apparatus 100, via an input device. Here, description will be given of a case in which a virtual area is set for the reference area corresponding to the intersection.

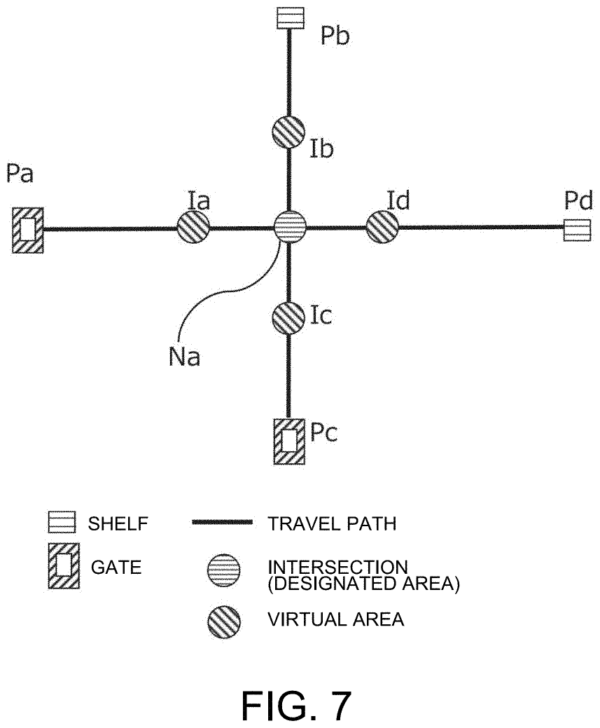

FIG. 7 is a diagram showing an example of virtual area set on each travel path coupled to a reference area (intersection) Na of the travel path network of FIG. 4. In this example, virtual areas Ia, Ib, Ic, and Id are set on the respective travel paths coupled to the intersection Na, at positions a predetermined distance away from the intersection Na.

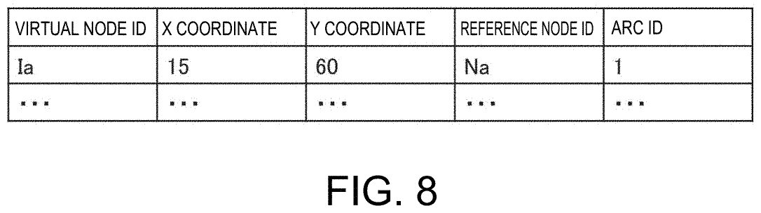

FIG. 8 shows an example of the virtual area DB 27. The virtual area (virtual node) Ia of FIG. 7 is set on a travel path (arc with an ID of 1) coupled to the reference area (reference node) Na, The X-Y coordinates of the virtual area Ia are (15, 60).

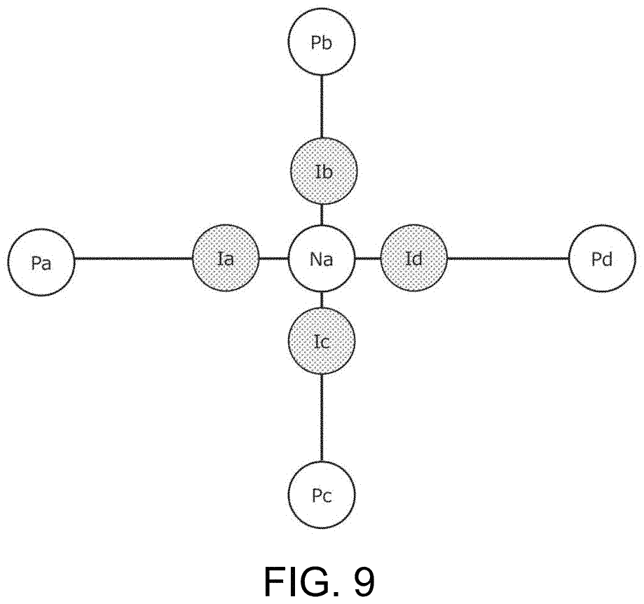

FIG. 9 shows an example in which virtual nodes are added to structure information about the travel path network shown in FIG. 7. On the arcs coupled (or connected) to the reference node Na, virtual nodes Ia, Ib, Ic, and Id are set, respectively, at positions a predetermined distance away from the reference node Na. Note that the virtual nodes are denoted by the same reference signs as the corresponding virtual areas. Virtual nodes can also be set for the reference nodes Pa to Pd. The virtual nodes can be set, at positions a predetermined distance away from the reference nodes Pa to Pd, for example, on the respective arcs coupled to the reference nodes Pa to Pd.

The mobile object information DB 24 stores information about one or more mobile objects. The mobile object information DB 24 stores, for example, positional information about mobile object/bodies. As an example, the positional information about the mobile object/bodies is real-time positional information (the latest positional information). For example, data containing positional information may be received from the mobile object/bodies every predetermined time and the positional information about the mobile object/bodies may be acquired from the received data. Alternatively, when a sensor provided in the travel path network detects passage of a mobile object, data informing passage of the mobile object may be received from a communication device connected to the sensor. The positional information about the mobile object/bodies may be positional information about a mobile object on standby yet to be assigned an operation information. In that case, a standby position of the mobile object may be learned by receiving data containing the positional information from the communication device connected to the sensor installed on the mobile object on standby or in a waiting place. The data containing the positional information is received by the communicator 11. The positional information may be history information about positions passed by the mobile object so far. Examples of possible information other than positional information include remaining power in the battery carried by the mobile object, information as to whether the mobile object carries a load (when the mobile object is intended to convey loads), and the type and number of loads being conveyed. Examples of information specific to the mobile object include specification information about the mobile object including standard speed, maximum speed, minimum speed, size of the mobile object, and movable direction. If the mobile object is intended to convey loads, possible examples of information also include the working time required for loading/unloading (e.g., the time required to load or unload a predetermined number of loads). The information cited here is only exemplary, and other information may be used.

The operation information DB 25 stores operation information (task information) about operations (tasks) to be assigned to one or more mobile objects. The operation information is generated by the task generation apparatus (operation information generation apparatus) 200, and is received by the operation management apparatus 100.

The task generation apparatus 200 includes, for example, an input interface for operating the operation management apparatus 100, and accepts a task generation instruction from a user, who is an operator, through an input interface. The task generation instruction may include an instruction of a departure point, an arrival point, or work carried out at the departure point and between the departure points. The task generation apparatus 200 generates a departure point, and a task for causing a mobile object to travel to an arrival point, and transmits task information about the generated task as operation information to the operation management apparatus 100.

The operation management apparatus 100 associates the operation information received from the task generation apparatus 200 with information (state information) indicating an execution state of the operation information, and stores the information in the operation information DB 25. The operation information includes information about departure points and arrival points. In addition to the departure points and arrival points, the operation information may include details and sequence of work to be carried out by the mobile object/bodies. The operation information may be entered by the user via an input device or acquired from an external apparatus by wired or wireless communication.

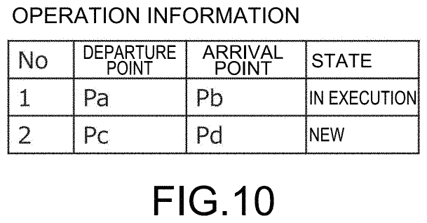

FIG. 10 shows an example of operation information. The operation information of FIG. 10 assumes the case of the travel path network of FIG. 4. The example of FIG. 10 shows two pieces of operation information. The first piece of operation information includes a departure point Pa and arrival point Pb. This means that the mobile object starts from the departure point Pa and arrives at the arrival point Pb. The second piece of operation information includes a departure point Pc and arrival point Pd. This means that the mobile object starts from the departure point Pc and arrives at the arrival point Pd. The operation information is assigned information (state information) indicating the execution state of the task. The state information includes “IN EXECUTION”, “NEW”, “PENDING” and “UNEXECUTED”.

“IN EXECUTION” means that the operation information has been assigned to the mobile object, and the task has already been executed. “NEW” means that after reception of the operation information from the task generation apparatus and storing of the information in the operation information DB 25, the process of the operation planner 12 has not been applied yet. “PENDING” means that execution of the task about the operation information is determined to be pending by the process of the operation planner 12. When the operation information is stored in the operation information DB 25 at the first time, “NEW” is assigned. “UNEXECUTED” means that pending of the process of the operation plan is finished for the mobile object. The state information transitions in a sequence of “NEW” and “IN EXECUTION”, or transitions in a sequence of “NEW”, “PENDING”, “UNEXECUTED” and “IN EXECUTION”.

The operation planner 12 selects the operation information from the operation information DB 25, determines the mobile object to be assigned the selected operation information, and assigns the operation information to the determined mobile object. The selected operation information is the operation information about “NEW” or “UNEXECUTED”. For the mobile object assigned the operation information, the operation planner 12 generates a route (hereinafter, a travel route) on which the mobile object travels, based on the operation information assigned to the mobile object and on information about the mobile object in the mobile object information DB 24. The travel route includes the sequence of reference areas through which the mobile object passes. The operation planner 12 determines timing to start from or pass through the reference areas (hereinafter, departure/passage timing) included in the travel route. The travel timing is identified by the time on a clock provided on the operation management apparatus 100 as an example. When the operation state is obtained by the task obtainer 15, the operation planner 12 may determine the mobile object to be assigned the operation information.

The travel route and the departure/passage timing may be determined so as not to cause a deadlock, a collision or the like with another mobile object, for example. Regarding a method for determining the travel route and the departure/passage timing, any appropriate method can be used. For example, a travel route and departure/passage timing where no deadlock or the like occurs may be determined by searching for all the travel pattern of the mobile objects through simulation. At this time, a standard speed may be used as the travel speed of the mobile object. The standard speed may be defined in conformity with the characteristics of the mobile object, the characteristics of the travel path (e.g., the material of the travel path etc.), the gradient of the travel path or the like. In this case, a condition of a possibility of occurrence of a deadlock or the like may be defined, and travel patterns that do not satisfy the condition may be retrieved. Alternatively, by first determining the travel routes of mobile objects, then departure times (passage times) from reference areas may be determined such that no deadlock or the like will occur with other mobile objects. The travel route may be a route minimizing the travel distance or the travel time from the departure point to the target point. The travel route and the departure/passage timing may be determined using another method.

The operation planner 12 identifies a reference area (referred to as a designated area) included commonly on the travel route of the mobile object, and a travel route of another mobile object in operation (a mobile object with operation information indicating in-operation). The operation planner 12 determines the passing sequence of the mobile object, for the designated areas. For example, this planner compares the departure times in the designated area among the mobile objects and determines the passing sequence such that the earlier the departure time, the earlier the order will be. The operation planner 12 generates passing sequence information that includes the determined passing sequence, or updates the passing sequence information. The travel route of each mobile object, and the passing sequence information are collectively referred to as an operation plan.

The operation plan DB 26 stores the operation plan created by the operation planner 12 (the travel route of each mobile object, and the passing sequence information).

A concrete example of operation of the operation planner 12 is shown below. First, operation of assigning the operation information (departure point: Pa, arrival point: Pb) to the mobile object is described. A case where no other mobile objects in operation are present is assumed.

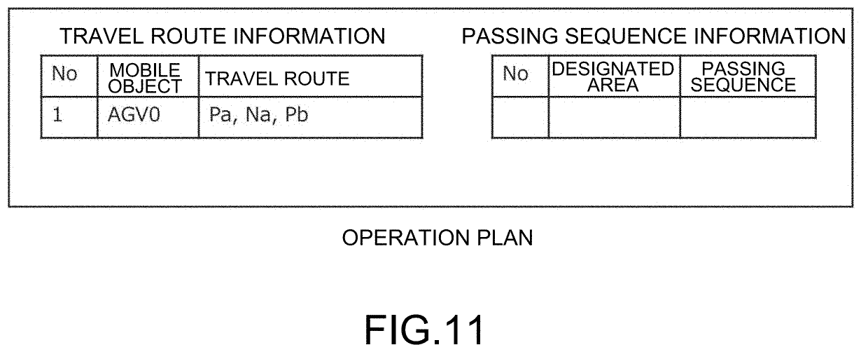

FIG. 11 shows an example of an operation plan obtained by the operation planner 12. As a mobile object, AGV0 is selected. As the travel routes of AGV0, Pa, Na and Pb are determined. There is not any mobile object in operation (mobile object assigned the operation information) before AGV0. Accordingly, no passing sequence information is generated (the passing sequence information is blank in the diagram). On the first row of travel route information, “AGV0” that is identification information (ID) about AGV0, and travel routes (Pa, Na and Pb) are included.

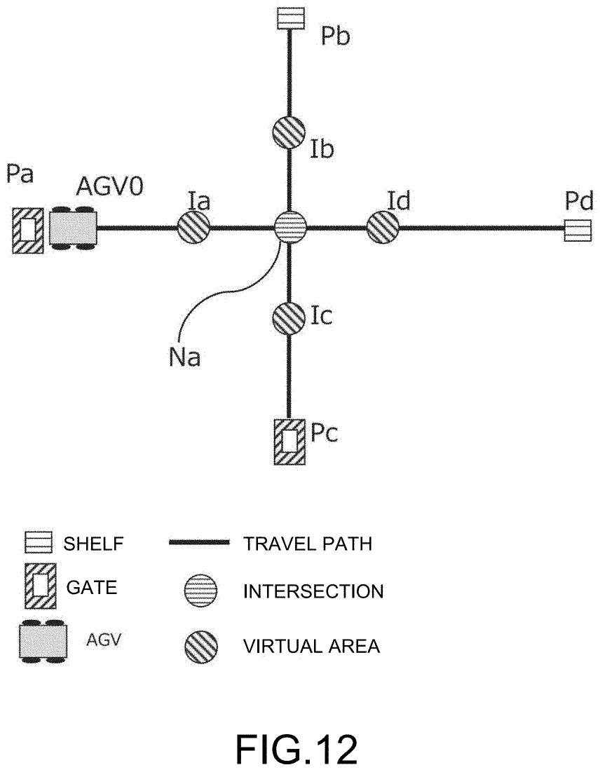

FIG. 12 shows a state in which AGV0 is located at the departure point Pa indicated by the operation plan in the travel path network shown in FIG. 4. In FIG. 12, travel paths are represented by straight lines for convenience. Note that before the operation plan is created, AGV0 is located at the departure point Pa, and the operation planner 12 assigns operation information to AGV0 using the information that AGV0 is located at the point Pa. However, AGV0 may be located at the point Pa, after being assigned operations.

The travel controller 13 controls travel of mobile objects based on the mobile object operation plan (travel route information and passing sequence information) in the operation plan DB 26. Specifically, the travel controller 13 obtains the travel route of the mobile object, based on the operation plan. The travel controller 13 generates one or more instructions in relation to each of the plurality of reference nodes (reference areas) included in the travel route. Details will be described below.

The first reference area on the travel route corresponds to the departure point (start position) of the mobile object. Regarding the first reference area, an instruction to move to the departure point is generated (note that if already located at the departure point, the mobile object does not move even if the move instruction is executed).

The last reference area on the travel route corresponds to the arrival point (end position) of the mobile object. Regarding the last reference area, an instruction to move to the arrival point is generated.

Regarding any of reference areas other than the first reference area and last reference area, instructions are generated by the following method.

A travel path coupled before the reference area is identified. A virtual area (hereinafter referred to as a virtual area A) set for the reference area on the identified travel path is identified. Also, a travel path coupled after the reference area is identified. A virtual area (hereinafter referred to as a virtual area B) set for the reference area on the identified travel path is identified.

Next, the following instructions are generated: an instruction to move to the virtual area A (first instruction), an instruction to check whether it is permitted to pass through the reference area (second instruction), an instruction to move to the virtual area B when it is permitted to pass through the reference area (third instruction), and an instruction to transmit information to the operation management apparatus 100, indicating that the reference area has been passed after moving to the virtual area B (fourth instruction). In this way, four instructions are generated with regard to one reference area.

The travel controller 13 arranges instructions generated, respectively, for the plurality of reference areas included in the travel route according to arranging sequence of the reference areas, the reference areas being included in the travel route, and thereby generates move command data. The move command data is data for instructing the mobile object assigned the operation information to travel on the travel route defined by the operation plan.

For all the reference area other than the first and last reference areas, the first to fourth instructions are thus generated. Alternatively, only for designated areas (reference areas included in the passing sequence information) among the reference areas, the first to fourth instructions may be generated. In this case, for the reference areas other than the designated areas among the reference areas other than the first to last reference areas, it is only required to generate an instruction to move to the reference area.

An execution start time of a first instruction included in the move command data may be added. The execution start time of the first instruction may coincide with the departure time from a reference area in the travel plan. If work carried out by the mobile object is included in the travel route, the instruction corresponding to the work is also added to the move command data. Examples of the work include receiving a load from a gate, carrying the received load to a shelf, and loading the load onto the shelf. Unloading the load from the shelf is also included.

The travel controller 13 transmits the generated move command data to the mobile object via the communicator 11. The communicator 11 includes a first transmitter that transmits the move command data to a first mobile object, and a second transmitter that transmits the move command data to a second mobile object. The operation planner 12 updates the state in the operation information assigned to the mobile object after or before transmission of the move command data, from “NEW” to “IN EXECUTION”. Note that upon receiving a notice that execution of the move command data has been completed as the situation of execution of the move command data by the mobile object, the travel controller 13 may remove the operation information from the operation information DB 25. Alternatively, “COMPLETED” may be defined as the state of the operation information, and the state of the operation information may be caused to transition from “IN EXECUTION” to “COMPLETED”.

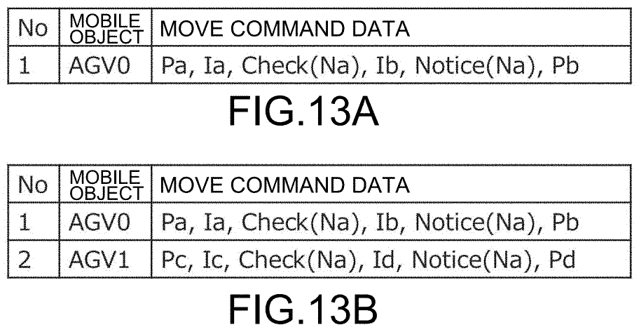

FIG. 13A shows an example of move command data generated for AGV0. Hereinafter, an example of generating the move command data in FIG. 13A is described. The travel route of AGV0 includes the reference areas Pa, Na and Pb.

Pa that is the first reference area corresponds to the departure point. Accordingly, an instruction to move to the point Pa is generated. “Pa” in FIG. 13A means an instruction to move to Pa. Note that in the present example, since AGV0 has already been located at the departure point, even if this instruction is executed, it is assumed that AGV0 does not move actually. Therefore, generation of the instruction to move to Pa may be omitted.

For the area Na that is the second reference area, the travel path for travel just before the area Na is identified. On the identified travel path, the virtual area Ia set for the area Na is identified. The travel path for travel just after the area Na is identified. On the identified travel path, the virtual area Ib set for the area Na is identified. The following instructions are generated: an instruction “Ia” to move to the virtual area Ia, an instruction “Check(Na)” to check whether it is permitted to pass through the designated area Na (start from or pass through the virtual area Ia), an instruction to move to the virtual area Ib (start from or pass through the virtual area Ia) when it is permitted to pass through the designated area Na, and an instruction “Notice(Na)” to transmit information to the operation management apparatus 100, indicating that the designated area Na has been passed (the virtual area Ib has been reached) after moving to the virtual area Ib. “Check(Na)” corresponds to an instruction to check whether the designated area Na has been passed and “Notice(Na)” corresponds to an instruction to notify completion of passage through the designated area Na.

Note that that AGV0 cannot move further than the virtual area Ia before being permitted to pass through the area Na by the travel controller 13 through execution of “Check(Na).” For example, if AGV0 reaches the virtual area Ia before receiving permission to pass through the area Na, AGV0 temporarily stops in the virtual area Ia. On the other hand, in the virtual area Ib, AGV0 does not need to execute “Notice(Na)” upon reaching the virtual area Ib and temporarily stop in the virtual area Ib.

Since the third area Pb is an arrival point, an instruction “Pd” to move to the arrival point Pb is generated.

If the instructions thus generated are arranged in the order in which the reference areas included in the travel route are arranged, the move command data shown in FIG. 13A is generated for AGV0.

Subsequently, operation of assigning the operation information (departure point: Pc, arrival point: Pd) to the mobile object is described. It is assumed that AGV0 has already been assigned the operation information and AGV0 is executing the move command data. The state of the operation information is assumed to be “IN EXECUTION” shown in the example of FIG. 10.

It is assumed that AGV1 is selected as a mobile object to be assigned the operation information (departure point: Pc, and arrival point: Pd), and Pc, Na and Pd are determined as the travel route of AGV1.

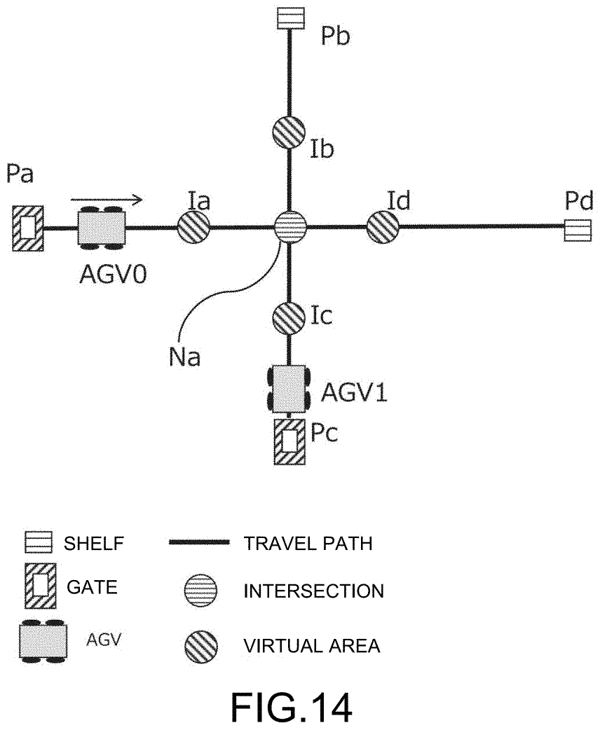

FIG. 14 shows a state in which AGV1 is located at the departure point Pc indicated by the operation plan in the travel path network shown in FIG. 4. AGV0 is in operation (move command data in execution).

AGV0 is present as a mobile object in operation (move command data in execution) earlier than AGV1. The presence of AGV0 in operation can be determined from the operation information DB 25, for example. The operation planner 12 compares the travel route of AGV1 with the travel route of the mobile object already in operation (here, AGV0), and determines whether both the travel routes include the same reference area (designated area). If the same reference area is not included, similar to AGV0 the move command data is generated for AGV1, and the move command data is transmitted to the mobile object (AGV1). Note that the travel route of the mobile object already in operation can be identified by sequentially tracing the destination of the instruction included in the move command data for this mobile object. Alternatively, the travel route of the mobile object already in operation can be identified from the operation plan.

On the other hand, if the same reference area is included in both the travel routes, it is determined whether the travel route of AGV1 contends with the travel route of AGV0 already in operation. Contention of the travel routes means that the operation of the mobile object already in operation delays or possibly delays.

An example is that the travel route of the target mobile object (here, AGV1) and the travel route of the mobile object already in operation (here, AGV0) include the same reference area, and the mobile object in operation has not passed the same reference area yet (contention example 1).

Another example is that the travel route of the target mobile object (here, AGV1) and the travel route of the mobile object already in operation (here, AGV0) include the same reference area, and the order of the target mobile object (here, AGV1) in the passing sequence information is sometimes earlier than the mobile object already in operation (here, AGV0) (contention example 2).

To determine whether the travel route of AGV1 contends with the travel route of AGV0, any of the contention examples 1 and 2 may be used. The contention examples described above are only exemplary ones. Only if there is a possibility of delaying the operation of another mobile object, another case may be adopted.

Contention of the travel route of AGV1 with the travel route of AGV0 already in operation is sometimes referred to as contention of the operation information about AGV1 with the operation information about AGV0.

In a case of using the contention example 1, if it is determined not to contend, similar to AGV0 the move command data is generated for AGV1, and the generated move command data is transmitted to the mobile object (AGV1). In a case of using the contention example 2, if it is determined not to contend, the passing sequence information that includes the determined passing sequence is generated, or the passing sequence information is updated (if the passing sequence information has already been generated). Similar to AGV0, the move command data is then generated for AGV1, and the generated move command data is transmitted to the mobile object (AGV1).

In the case of using the contention example 1 or the contention example 2, if both the travel routes are determined to contend with each other, a pending task is generated for the operation information assigned to the target mobile object (AGV1). For example, the pending task includes: an identifier of the mobile object (AGV0) assigned the operation information; the departure point; the arrival point; a passage check area (passage check node); and an identifier of the operation information determined to contend. The passage check area is a reference area that is a cause of contention. That is, the passage check area is a reference area commonly included in the travel route of the target mobile object and the travel route of the mobile object already in operation, and is a reference area that is a cause of determination of contention. In the present example, the contention example 1 or the contention example 2 is used, the route of AGV1 is determined to contend with the route of AGV0, and the pending task is generated.

The operation planner 12 stores the pending task in the pending task DB 28. The pending task DB 28 may be integrated in the operation information DB 25, and the pending task and the operation information may be managed as one record.

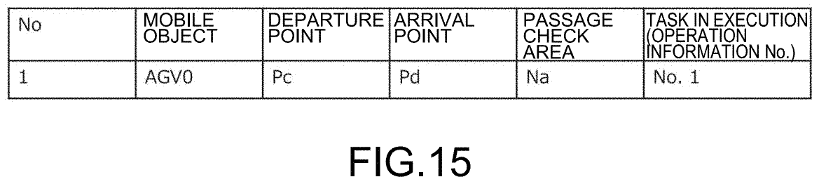

FIG. 15 shows an example of the pending task DB 28. In the example in the figure, a pending task generated for AGV1 is stored. The pending task of AGV1 includes AGV1's departure point Pc, arrival point Pd, passage check area, and the identifier (No.) of the contending operation information (task in execution).

The operation planner 12 updates the state of the operation information about the pending task, to “PENDING”.

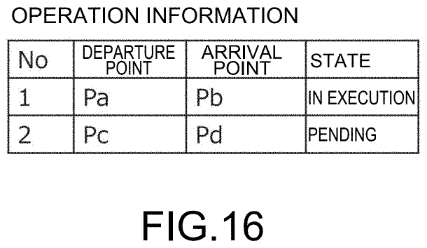

FIG. 16 shows an example where the state of operation information about AGV1 (operation information No. 2) is updated to “PENDING”.

For the pending task stored in the pending task DB 28, the travel controller 13 determines whether the mobile object operating the task of the contending operation information has passed through the passage check area. That is, the execution situation of the move command data on the mobile object that is operating the task of the contending operation information is inspected. In the example in FIG. 14, it is determined whether AGV0 has passed through the passage check area Na. It can be determined whether AGV0 has passed through the passage check area Na or not, by determining an instruction up to which execution has been carried out among the instructions included in the move command data on AGV0.

Specifically, upon receiving a notice of “Notice(Na)” from AGV0, the travel controller 13 determines that the passage check area Na has been passed. Alternatively, in case the notice of “Notice(Na)” cannot be received owing to the communication environment, it may be determined that the passage check area Na has been passed upon receiving a notice that any instruction arranged after “Notice(Na)” has been executed. Alternatively, when AGV0 is located between the virtual area Ia before the passage check area and the virtual area Ib after the passage check area, it may be assumed that AGV0 has passed through the passage check area Na. If “Check(Na)” (third instruction) has been executed but “Notice(Na)” (fourth instruction) has not been executed yet, it can be determined that AGV0 is located between the virtual area Ia and the virtual area Ib. Alternatively, the fact that AGV0 is located between the virtual area Ia and the virtual area Ib may be detected by obtaining positional information from the mobile object through communication. A test of whether AGV0 is located between the virtual area Ia and the virtual area Ib may be carried out at certain time intervals.

If the travel controller 13 determines that AGV0 has passed through the passage check area Na, the operation planner 12 removes the pending task of AGV0 from the pending task DB 28. As described above, according to the execution situation of the move command data on the contending mobile object, the pending task is removed from the pending task DB 28. Specifically, if the execution situation is changed and AGV0 has passed through the passage check area Na, it is assumed that the contention is resolved, and the pending task is removed. The operation planner 12 updates the state of the operation information about the mobile object (AGV1) pertaining to the pending task from “PENDING” to “UNEXECUTED”.

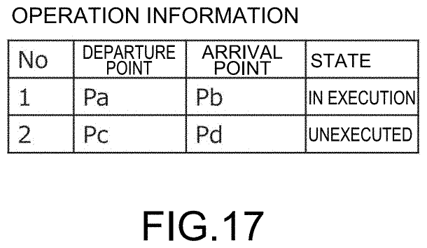

FIG. 17 shows an example where the state of operation information about AGV1 (operation information No. 2) is updated to “UNEXECUTED”.

The operation planner 12 selects the operation information “NEW” or “UNEXECUTED” from the operation information DB 25. In the example in FIG. 17, the operation information “No. 2” with “UNEXECUTED” is selected. The mobile object to be assigned the selected operation information is the same as AGV1 (the mobile object pertaining to the pending task), which is the same as that last time. The operation planner 12 then determines the travel route of AGV1, based on the selected operation information. As described above, the operation planner 12 creates the travel route for the mobile object (AGV1) pertaining to the pending task removed from the pending task DB 28 owing to change of the execution situation of the move command data for AGV0. That is, the operation planner 12 generates the travel route of AGV1, based on the operation information about “AGV1” according to the execution situation of the move command data for AGV0. The operation planner 12 determines the departure/passage timing of AGV1 on the travel route of AGV1. The operation planner 12 redetermines whether the travel route of AGV1 contends with the travel route of AGV0 in operation. As a method of determining contention on the travel route, the contention example 1 or 2 described above may be used.

That is, in the case of using the contention example 1 described above, it is determined whether the reference area (designated area) identical to that on the travel route of AGV0 in operation is included on the travel route of AGV1. In the present example, the designated area Na is included. If AGV0 has already passed through the designated area, the operation planner 12 determines that contention is not to occur.

In the case of using the contention example 2 described above, it is determined whether the reference area (designated area) identical to that on the travel route of AGV0 in operation is included on the travel route of AGV1, and the passing sequence of the designated area by AGV0 is earlier than AGV1. The passing sequence of the designated area is calculated by the passing sequence calculator 14. The passing sequence calculator 14 calculates the sequence of AGV1 and AGV0 to pass through the designated area, based on the designated area travel timing of each of AGV0 and AGV1. If the passing sequence of AGV0 is earlier than that of AGV1, it is determined that the travel route of AGV1 is not to contend with the travel route of AGV0.

In the present example, AGV0 has already passed through the passage check area Na that is the designated area. Accordingly, the operation planner 12 determines that the travel route of AGV1 does not contend with the travel route of AGV0.

As described above, if the travel route of AGV1 contends with the travel route of AGV0, the operation planner 12 regenerates the travel route of AGV0 according to the execution situation of the move command data for AGV0. This operation is repetitively carried out until the travel route of AGV1 without contention with the travel route of AGV0 is obtained. Note that the regenerated travel route of AGV1 is the same as the travel route of AGV1 generated before regeneration in some cases, and is different therefrom in other cases. The regenerated travel route of AGV1 can vary according to the execution situation of the move command data for AGV0.

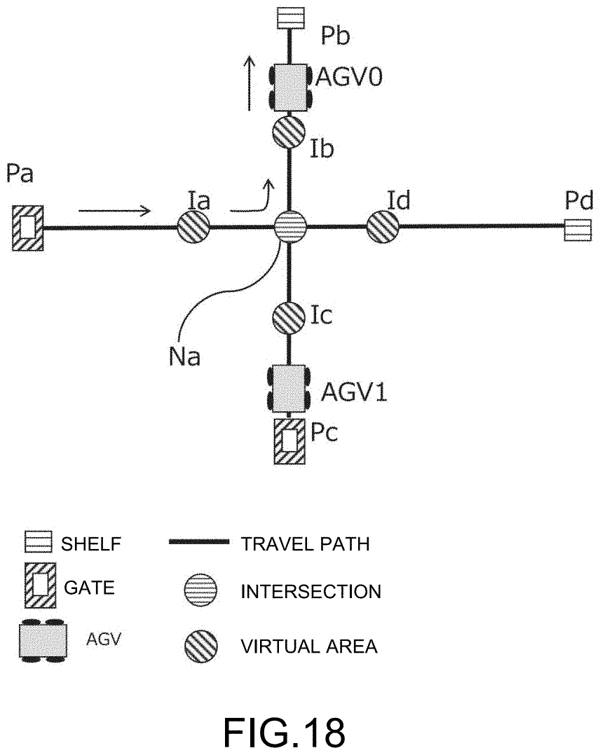

FIG. 18 shows the state of the travel path network after notification that AGV0 has already passed through the area Na is issued to the operation management apparatus 100 by execution of “Notice(Na)”.

The travel controller 13 generates the move command data for AGV1, based on the travel route of AGV1. The travel controller 13 transmits the generated move command data to AGV1 through the communicator 11.

FIG. 13B shows an example of move command data generated for AGV1 on a row of “No. 2”.

The operation planner 12 updates the state of operation information about “AGV1” from “UNEXECUTED” to “IN EXECUTION”.

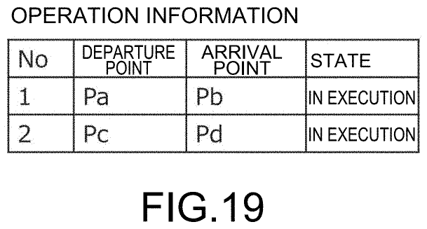

FIG. 19 shows an example where the state of operation information about AGV1 (operation information No. 2) is updated from “UNEXECUTED” to “IN EXECUTION”.

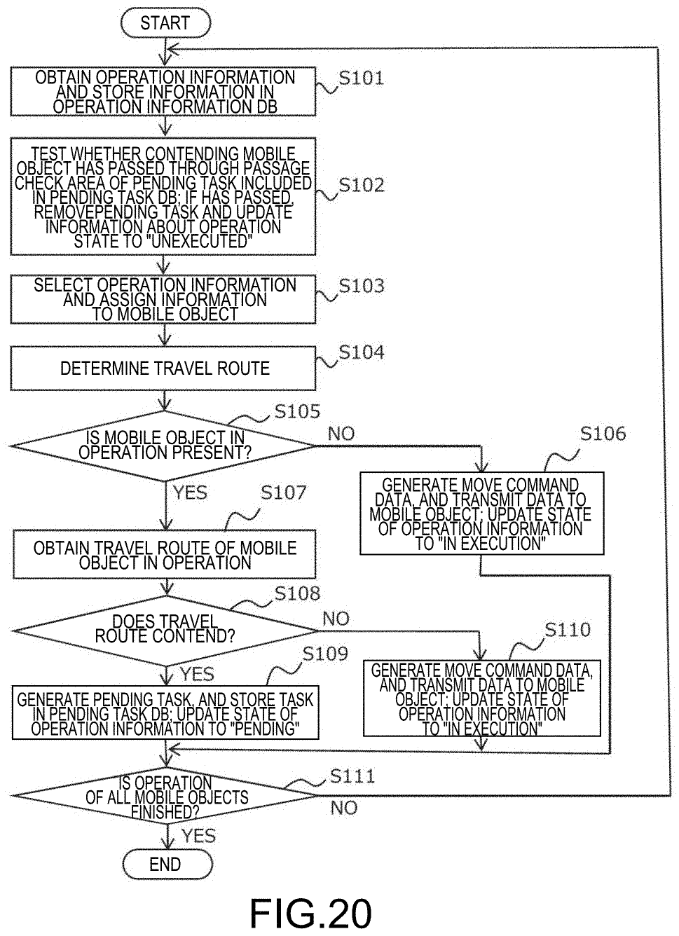

FIG. 20 is a flowchart of an operation example of the operation management apparatus 100 according to the present embodiment.

When the task generation apparatus 200 generates information (operation information) about a task to be assigned to the mobile object, the task obtainer 15 obtains the operation information, and stores the obtained operation information in the operation information DB 25 (S101). “NEW” is set as the initial value of the state of the operation information.

For the pending task included in the pending task DB 28, the travel controller 13 tests whether the contending mobile object (task executing mobile object) has passed through the passage check area (S102). If it has passed, the operation planner 12 removes the pending task, and changes the state of the operation information from “PENDING” to “UNEXECUTED”. The travel controller 13 may test whether the contending mobile object has passed through the passage check area, for the pending task, at certain time intervals. As described above, according to the execution situation of the move command data on the contending mobile object, the pending task is removed from the pending task DB 28. Accordingly, in the next step, the travel route is generated for the mobile object pertaining to the removed pending task, based on the operation information about the mobile object.

The operation planner 12 selects the operation information with the state of “NEW” or “UNEXECUTED” from the operation information DB 25, and determines the mobile object to be assigned the operation information, based on the selected operation information (S103). The sequence of selection of the operation information may be any sequence, or may be defined by a predetermined rule. For example, “UNEXECUTED” may have priority over “NEW”. Alternatively, the operation information may be assigned priority, and selected in a descending order of priority. The sequence of selection may be determined by another method. When the operation state is obtained by the task obtainer 15, the operation planner 12 may determine the mobile object to be assigned the obtained operation information.

The operation planner 12 determines the travel route for the target mobile object, based on the operation information. The departure/passage timing of the reference area included in the travel route is determined (S104). It is checked whether operation information “IN EXECUTION” is present, that is, whether a mobile object in operation is present (S105). If not (NO in S105), the move command data is generated based on the travel route, and the generated move command data is transmitted to the mobile object (S106). The state of the operation information is updated to “IN EXECUTION” (the same S106).

If the mobile object in operation is present (YES in S105), the travel route of the mobile object in operation is obtained (S107). The travel route may be identified, for example, based on the mobile object command data executed by the mobile object, or identified based on the mobile object operation plan. It is determined whether the travel route of the target mobile object contends with the travel route of the mobile object in operation, based on the contention example 1 or the contention example 2 described above (S108). If the travel route of the target mobile object includes the reference area common to the travel route of the mobile object in operation, the passing sequence of the reference area is determined.

If it does not contend (NO in S108), the move command data is generated based on the travel route, and the generated move command data is transmitted to the mobile object (S110). The state of the operation information is updated to “IN EXECUTION” (the same S110). In a case of using the contention example 2, the travel route of the target mobile object includes the reference area common to the travel route of the mobile object in operation, the passing sequence information is generated or updated based on the determined passing sequence described above.

If it contends (YES in S108), a pending task is generated, and the generated pending task is stored in the pending task DB 28 (S109).

It is determined whether the operations of all the mobile objects are finished (S111). If finished (YES in S111), the present process is finished. If not finished (NO in S111), the processing returned to step S101.

As described above, according to the present embodiment, if the travel route of the mobile object contends with the travel route of the mobile object in operation, the operation information about the mobile object is made pending as a pending task. If the cause of the contention (the contention example 1 or the contention example 2 described above) is resolved, the operation plan (travel route etc.) is regenerated based on the operation information. Accordingly, also if new operation information occurs during operation of the mobile object, the task based on the new operation information can be executed by another mobile object without disturbing the mobile object in operation.

### [Variation 1]

In the embodiment described above, the operation plan (travel route etc.) of the target mobile object is created without stopping the mobile object in operation. Alternatively, the mobile object in operation may be temporarily stopped.

For example, the mobile object in operation may be temporarily stopped in the virtual area before the designated area. Accordingly, in the middle of the process of creating the operation plan of the target mobile object, the mobile object in operation passes through the designated area, which can prevent occurrence of a contradiction in passing sequence before and after creation of the operation plan.

In this case, even if a notice based on “Check” instruction is received in the virtual area from the mobile object in operation, the travel controller 13 is not required to issue permission of passage. After completion of the process of the target mobile object, the travel controller 13 may transmit permission notice. For example, if the travel route of the mobile object is determined or the move command data is transmitted to the mobile object, permission notice is transmitted.

Even if the mobile object in operation to be temporarily stopped is present, the mobile object in operation that does not include the reference area common to that of the target mobile object is not temporarily stopped. Accordingly, reduction in the efficiency of the entire system is suppressed.

### [Variation 2]

While the mobile object in operation passes through the designated area (located between the virtual area before the designated area and the virtual area after the designated area), the passage of the mobile object in operation through the designated area is waited for, and after the passage through the designated area, the process of creating the operation plan of the target mobile object may be carried out. Accordingly, the passing sequence is prevented from being contradicted in passing sequence before and after creation of the operation plan. The passage of the mobile object in operation through the designated area can be determined by, for example, the travel controller 13 receiving a notice based on “Notice” instruction.

### [Variation 3]

In the embodiment described above, what includes at least travel from the departure point to the arrival point is defined as the task. The task may be defined in a different manner. For example, the task may be what starts charging when the mobile object becomes below a certain threshold. The task may be what changes the travel path network after lapse of a certain time period. Examples of changing the travel path network include what disables a part of the travel path, and what adds a new travel path. The case of changing the travel path network may be accompanied by update of at least one of the travel path information DB 21, the reference area DB 22 and the travel path network information DB 23. Each of the charging task, and the travel path network changing task may be generated in the task generation apparatus 200 through a user input, and the information about the task may be input into the operation management apparatus 100. The operation management apparatus 100 transmits an instruction of executing the task to the mobile object concerned using the communicator 11, or the task is executed by a controller (not shown) of the operation management apparatus 100.

(Hardware Configuration)

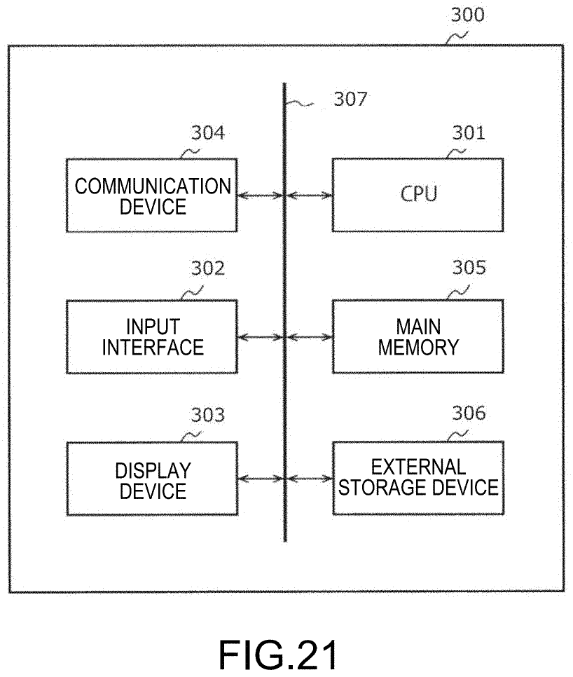

FIG. 21 illustrates a hardware configuration of the operation management apparatus (information processing apparatus) 100 of FIG. 1. The information processing apparatus 100 according to the present embodiment is configured with a computer device 300. The computer device 300 includes a CPU 301, an input interface 302, a display device 303, a communication device 304, a main storage device 305 and an external storage device 306, and these are connected to each other with a bus 307.

The CPU (Central Processing Unit) 301 executes a computer program (operation management program) which realizes the above-described respective functional configurations of the information processing apparatus 100 on the main storage device 305. The computer program may not be a single program but a plurality of programs or a combination of scripts. By the CPU 301 executing the computer program, the respective functional configurations are realized.

The input interface 302 is a circuit for inputting an operation signal from the input device such as a keyboard, a mouse and a touch panel, to the information processing apparatus 100. The input function of the information processing apparatus 100 can be constructed on the input interface 302.

The display device 303 displays data or information output from the information processing apparatus 100. While the display device 303 is, for example, an LCD (Liquid Crystal Display), a CRT (Cathode-Ray Tube), and a PDP (Plasma Display Panel), the display device 303 is not limited to this. The data or the information output from the computer device 300 can be displayed by this display device 303. The output device of the information processing apparatus 100 can be constructed on the display device 303.

The communication device 304 is a circuit for the information processing apparatus 100 to communicate with an external device in a wireless or wired manner. Information can be input from the external device via the communication device 304. Information input from the external device can be stored in a DB.

The main storage device 305 stores a program (operation management program) which realizes processing of the present embodiment, data required for execution of the program, data generated by execution of the program, and the like. The program is developed and executed on the main storage device 305. While the main storage device 305 is, for example, a RAM, a DRAM and an SRAM, the main storage device 305 is not limited to this. The storage in each embodiment may be constructed on the main storage device 305.

The external storage device 306 stores the above-described program, data required for execution of the program, data generated by execution of the program, and the like. These kinds of program and data are read out to the main storage device 305 upon processing of the present embodiment. While the external storage device 306 is, for example, a hard disk, an optical disk, a flash memory and a magnetic tape, the external storage device 306 is not limited to this. The storage in each embodiment may be constructed on the external storage device 306.

Note that the above-described program may be installed in the computer device 300 in advance or may be stored in a storage medium such as a CD-ROM. Further, the program may be uploaded on the Internet.

Note that the computer device 300 may include one or a plurality of the processors 301, the input interfaces 302, the display devices 303, the communication devices 304 and the main storage devices 305, or peripheral equipment such as a printer and a scanner may be connected to the computer device 300.

Further, the information processing apparatus 100 may be configured with a single computer device 300 or may be configured as a system including a plurality of computer devices 300 which are connected to each other.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A travel control apparatus, comprising:
a first transmitter configured to transmit first move command data for instructing a first mobile object to travel on a first route;
an operation planner configured to generate a second route for a second mobile object, according to an execution situation of the first move command data by the first mobile object; and
a second transmitter configured to transmit second move command data for instructing the second mobile object to travel on the second route.

2. The travel control apparatus according to claim 1,
wherein the operation planner determines whether the second route contends with the first route,
when the second route contends with the first route, the second transmitter does not transmit the second move command data, and
after the contention is resolved, the operation planner regenerates the second route.

3. The travel control apparatus according to claim 2,
wherein the first route includes a first reference area,
the second route includes the first reference area, and
when the first mobile object has not yet passed through the first reference area, the operation planner determines that the second route contends with the first route.

4. The travel control apparatus according to claim 3, further comprising
a passing sequence calculator configured to generate passing sequence information that includes a sequence of the first mobile object and the second mobile object passing through the first reference area,
wherein when the passing sequence information indicates that the second mobile object is to pass through the first reference area earlier than the first mobile object, the operation planner determines that the second route contends with the first route.

5. The travel control apparatus according to claim 4, further comprising
a travel controller configured to determine whether the first mobile object has passed through the first reference area,
wherein when the first mobile object has passed through the first reference area, the operation planner regenerates the second route.

6. The travel control apparatus according to claim 5,
wherein the travel controller tests whether the first mobile object has passed through the first reference area at time intervals.

7. The travel control apparatus according to claim 3,
wherein a first virtual area is set on a first travel path coupled to the first reference area in the first route, and a second virtual area is set on a second travel path coupled to the first reference area,
the travel control apparatus further comprises a travel controller configured to determine whether the first mobile object is located between the first virtual area and the second virtual area on the first route, and
when the first mobile object is located between the first virtual area and the second virtual area, the operation planner regenerates the second route.

8. The travel control apparatus according to claim 7,
wherein the travel controller tests whether the first mobile object is located between the first virtual area and the second virtual area at time intervals.

9. The travel control apparatus according to claim 7,
wherein the first move command data includes:
a first instruction to move to the first virtual area;
a second instruction to check with the travel control apparatus with respect to permission of passage through the first reference area;
a third instruction to move from the first virtual area to the second virtual area when the passage through the first reference area is permitted; and
a fourth instruction to transmit information that the first reference area has been passed, to the travel control apparatus, when the second virtual area is reached, and
when the third instruction has been executed and the fourth instruction has not been executed yet, the travel controller determines that the first mobile object is located between the first virtual area and the second virtual area.

10. The travel control apparatus according to claim 3,
wherein a first virtual area is set on a first travel path coupled to the first reference area in the first route, and a second virtual area is set on a second travel path coupled to the first reference area,
the first move command data includes:
a first instruction to move to the first virtual area;
a second instruction to check with the travel control apparatus with respect to permission of passage through the first reference area;
a third instruction to move from the first virtual area to the second virtual area when the passage through the first reference area is permitted; and
a fourth instruction to transmit information that the first reference area has been passed, to the travel control apparatus, when the second virtual area is reached, and
the travel control apparatus further comprises a travel controller configured to determine that the first mobile object has already passed through the first reference area, upon receiving, from the first mobile object, information indicating that the first reference area has been passed based on the fourth instruction.

11. The travel control apparatus according to claim 3,
wherein a first virtual area is set on a first travel path coupled to the first virtual area on the first route,
the travel control apparatus further comprises a travel controller configured to cause the first mobile object to wait in the first virtual area during a process of the operation planner, and
after the second route is generated for the second mobile object, or after the second move command data is transmitted to the second mobile object, the travel controller permits the first mobile object to pass through the first virtual area.

12. The travel control apparatus according to claim 1, further comprising
an obtainer configured to obtain operation information from an operation information generation apparatus configured to generate the operation information,
wherein when the operation information is obtained by the obtainer, the operation planner determines the second mobile object that is a mobile object to be assigned the operation information, and generates the second route for the second mobile object, based on the operation information.

13. The travel control apparatus according to claim 12, further comprising
an operation information storage configured to store at least one or more pieces of the operation information obtained by the obtainer,
wherein the operation planner selects a piece of the operation information from the operation information storage, determines the second mobile object that is a mobile object to be assigned the selected piece of the operation information, and generates the second route for the second mobile object, based on the operation information.

14. The travel control apparatus according to claim 1,
wherein the first route and the second route are routes in a travel path network, the travel path network including a plurality of travel paths and a plurality of reference areas coupling the travel paths to each other.

15. The travel control apparatus according to claim 14,
wherein the first move command data includes information instructing that the plurality of reference areas included in the first route are sequentially passed, and
the second move command data includes information instructing that the plurality of reference areas included in the second route are sequentially passed.

16. A travel control method, comprising:
transmitting first move command data for instructing a first mobile object to travel on a first route;
generating a second route for a second mobile object, according to an execution situation of the first move command data by the first mobile object; and
transmitting second move command data for instructing the second mobile object to travel on the second route.

17. A non-transitory computer readable medium having a computer program stored therein which causes a computer to perform processes, comprising:
transmitting first move command data for instructing a first mobile object to travel on a first route;
generating a second route for a second mobile object, according to an execution situation of the first move command data by the first mobile object; and
transmitting second move command data for instructing the second mobile object to travel on the second route.
